(19) United States
(12) Patent Application Publication
(10) Pub. No.: US 2015/0131529 A1
(43) Pub. Date: May 14, 2015

(54) SERVER AIDED NAN CLUSTER MERGING

(71) Applicant: QUALCOMM Incorporated, San Diego, CA (US)

(72) Inventors: Yan Zhou, San Diego, CA (US); Santosh Paul Abraham, San Diego, CA (US); George Cherian, San Diego, CA (US)

(21) Appl. No.: 14/539,182

(22) Filed: Nov. 12, 2014

Related U.S. Application Data
(60) Provisional application No. 61/904,321, filed on Nov. 14, 2013.

(51) Int. Cl. H04W 40/32; H04W 8/00

(52) U.S. Cl. CPC H04W 40/32; H04W 8/005
USPC 370/328

(57) ABSTRACT

One embodiment of this invention comprises an apparatus that desires to merge clusters in a neighbor aware network comprising a processing system, where the processing system is configured to generate a request to another apparatus to inform the apparatus when a neighboring cluster with a better cluster grade than the cluster of the apparatus exists, provide the request for transmission to the other apparatus, receive a response from the other apparatus informing of the neighboring cluster with the better cluster grade, scan for the neighboring apparatus, and merge with the neighboring cluster with the better cluster grade.

### CROSS REFERENCE TO RELATED APPLICATIONS

This Application claims the benefit of U.S. Provisional Application No. 61/904,321, filed Nov. 14, 2013, and entitled “SERVER AIDED NAN CLUSTER MERGING” and assigned to the assignee hereof. The disclosure of this prior application is considered part of this application, and is hereby incorporated by reference in its entirety.

### BACKGROUND

1. Field of the Invention

The present application relates generally to wireless network communications, and more specifically to systems, methods, and devices for merging clusters on a wireless network.

2. Description of the Related Art

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g. circuit switching vs. packet switching), the type of physical media employed for transmission (e.g. wired vs. wireless), and the set of communication protocols used (e.g. Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

One or more devices in a wireless network may be configured to provide services. For example, a device may include hardware, such as a sensor, that is used to capture data. An application running on the device may then use the captured data to perform an operation. In some cases, the captured data may be useful to other devices in the wireless network. Some other devices in the wireless network may include similar hardware so as to capture similar data. Alternatively, the device could provide these services (e.g., the captured data) to one or more other devices in the wireless network. The device may inform the one or more other devices in the wireless network of the services that the device provides by advertising this information over the wireless network. Other devices may further advertise the services provided by a device to other devices not within range or capable of direct communication with the service provider. However, communication of the aggregate of all available services, in combination with all necessary beaconing, messaging and computational overhead, may result in increased network loading and decreased data throughput availability given the required collision avoidance schemes implemented to avoid collisions of beacons and packets. Thus, improved systems, methods, and devices for communicating in a wireless network are desired.

### SUMMARY OF THE INVENTION

One embodiment of this invention comprises an apparatus for merging a station between clusters of stations in a neighbor aware network. The apparatus comprises a processing system. The processing system is configured to generate a request to a server on the network to inform the station when a cluster of stations that is preferred over a current cluster of stations to which the station belongs is identified. The processing system is further configured to provide the generated request for transmission to the server and to receive a response from the server, the response configured to identify the cluster of stations that is preferred over the current cluster of stations.

Another embodiment may comprise a method for a station to merge between clusters of stations in a neighbor aware network. The method comprises generating a request to a server on the network to inform the station when a cluster of stations that is preferred over a current cluster of stations to which the station belongs is identified. The method further comprises transmitting the request to the server and receiving a response from the server, the response identifying the cluster of stations that is preferred over the current cluster of stations.

An alternate embodiment may comprise an apparatus for a server to aid a first station to merge between clusters of stations in a neighbor aware network. The apparatus comprises a processing system configured to receive a request from an access point on the network to perform a search for a cluster of stations that is preferred over a current cluster of stations identified by the access point. The processing system is further configured to perform the search for the preferred cluster of stations. The processing system is also configured to generate a response to the access point, the response identifying the preferred cluster of stations, and provide the response for transmission to the access point.

Another embodiment may show a method implemented by a server for aiding a first station to merge between clusters of stations in a neighbor aware network. The method comprises receiving a request from an access point on the network to perform a search for a cluster of stations that is preferred over a current cluster of stations identified by the access point. The method further comprises performing the search for a cluster of stations that is preferred over the current cluster of stations. The method also comprises generating a response to the access point, the response identifying the preferred cluster, and transmitting the response to the access point.

An additional embodiment may comprise a server merging clusters of stations in a neighbor aware network. The apparatus comprises a processing system configured to determine a plurality of clusters of stations may overlap. The processing system is further configured to determine that at least one cluster of stations of the plurality of clusters of stations is preferred over one or more of the other clusters of stations of the plurality of clusters of stations. The processing system is also configured to generate a request to a station on the network in the one or more other clusters of stations of the plurality of clusters of stations to merge with the at least one of the plurality of clusters that is preferred. The processing system is further configured to provide for transmission the request to the station in the one or more other clusters of stations of the plurality of clusters of stations.

Another embodiment may include a method implemented by a server of merging clusters of stations in a neighbor aware network. The method comprises determining a plurality of clusters of stations may overlap. The method further comprises determining that at least one of the plurality of clusters of stations is preferred over one or more of the other clusters of stations of the plurality of clusters of stations. The method also comprises generating a request to a station on the network in one or more of the other clusters of stations of the plurality of clusters of stations to merge with the at least one of the plurality of clusters that is preferred. The method further comprises transmitting the request to the station in the one or more other clusters of stations of the plurality of clusters of stations.

### BRIEF DESCRIPTION OF THE DRAWINGS

FIG. 1 illustrates one possible organization of a wireless network system with multiple wireless networks, NAN clusters, and wireless devices.

FIG. 2 shows an embodiment of a device which may comprise one or more of the devices of FIG. 1.

FIG. 3 illustrates an embodiment of the structure of a message which may be used to communicate information between devices of FIG. 1.

FIG. 4A illustrates the communications exchanged between a requesting device and a server.

FIG. 4B illustrates the communications exchanged between a requesting device and a server with an access point acting as a proxy for the requesting device or an intermediary between the server and the requesting device.

FIG. 5 represents a flowchart of a method for a requesting device to request another device search for a neighboring NAN cluster to which the requesting device may join.

FIG. 6 shows a function block diagram of a requesting device requesting another device search for a neighboring NAN cluster with a better cluster grade.

FIG. 7 illustrates a flowchart of a method for a server to search for a neighboring NAN cluster with a better cluster grade for a requesting device.

FIG. 8 represents a function block diagram of a server searching for a neighboring NAN cluster with a better cluster grade for a requesting device.

### DETAILED DESCRIPTION

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Wireless network technologies may include various types of wireless local area networks (WLANs). A WLAN may be used to interconnect nearby devices together, employing widely used networking protocols. The various aspects described herein may apply to any communication standard, such as Wi-Fi or, more generally, any member of the IEEE 802.11 family of wireless protocols. For example, the various aspects described herein may be used as part of the IEEE 802.11ah protocol, which uses sub-1 GHz bands.

In some aspects, wireless signals in a sub-gigahertz band may be transmitted according to the 802.11ah protocol using orthogonal frequency-division multiplexing (OFDM), direct-sequence spread spectrum (DSSS) communications, a combination of OFDM and DSSS communications, or other schemes. Implementations of the 802.11ah protocol may be used for sensors, metering, and smart grid networks. Advantageously, aspects of certain devices implementing the 802.11 ah protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be three types of devices: access points (“APs”), relays, and clients (also referred to as stations, or “STAs”). In general, an AP serves as a hub or base station for the WLAN, a relay device provides a communication link between the AP for the WLAN and one or more STAs, which serve as users of the WLAN. For example, an STA may be a laptop computer, a personal digital assistant (PDA), a mobile phone, etc. In an example, an STA connects to an AP, through a relay device, via Wi-Fi (e.g., IEEE 802.11 protocol such as 802.11 ah) compliant wireless links to obtain general connectivity to the Internet or to other wide area networks. In some implementations, an STA may also be used as a relay device.

An access point (“AP”) may also comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

A discovery window (DW) may comprise a period of time during which devices and stations on a particular NAN or other network converge on a specified channel to synchronize information. During a discovery window, all associated NAN device may synchronize time synchronization via synchronization beaconing, which may be transmitted only during discovery windows. Additionally, a discovery window may include synchronizing beaconing, service broadcast transmissions, or service discovery frames being sent between NAN devices, or any other communication between NAN devices to which all NAN devices may be involved or interested. The discovery window may be periodic, repeating at specific periods.

A wireless device may comprise an access terminal (“AT”) or STA, an AP or a relay-capable wireless device having at least one of a STA or AP operation, i.e., a wireless device may have AT or STA operation, AP operation, or both AT/STA and AP operations.

As discussed above, certain of the devices described herein may implement the 802.11 ah standard, for example. Such devices, whether used as an STA, a relay device, an AP, or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

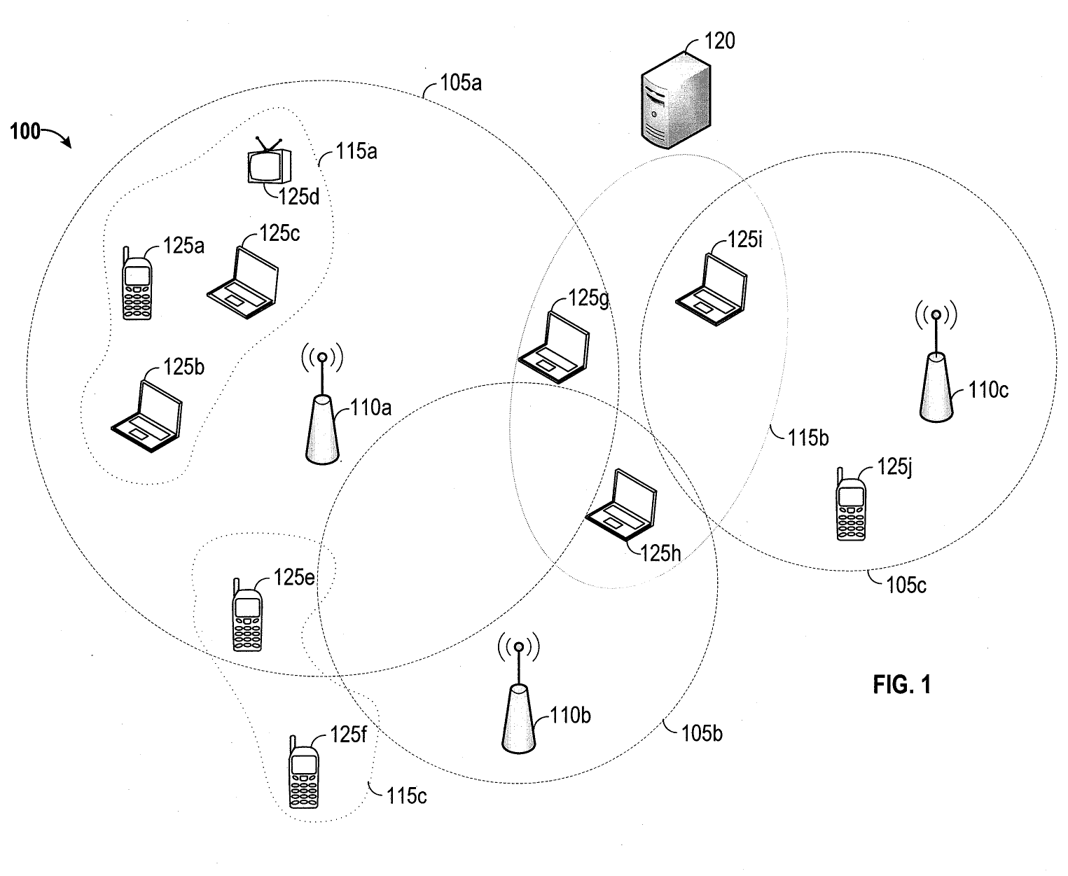

Referring to FIG. 1, a particular illustrative embodiment of a plurality of wireless networks and neighbor aware networks and associated wireless devices and server are depicted and generally designated 100. The wireless networks 105a, 105b, and 105c are depicted and contain a plurality of wireless devices 125a-j and wireless access points 110a-c. Additionally, server 120 is depicted and is not contained solely in any of the plurality of wireless networks or the neighbor aware networks, though it is connected via data connections (not shown) to each of wireless devices 125a-j and wireless access points 110a-c.

Wireless devices 125a-e and 125g are each “members” of wireless network 105a. These six wireless devices 125a-e and 125g may be referred to as “members” of the wireless network 105a as the six noted wireless devices are either actively or passively participating in communications on the wireless network 105a. Each of these wireless devices 125a-e and 125g may be communicating with wireless access point 110a. Similarly, wireless device 125h is a member of wireless network 105b and may communicate with wireless access point 110b. Additionally, wireless device 125i and 125j are each members of wireless network 105c. These two wireless devices may communicate with wireless access point 110c. Wireless device 125f is not a member of any wireless network 105a-c, and thus may not be communicating with any of wireless access points 110a-c.

In FIG. 1, wireless devices 125a-d are each members of NAN cluster 115a through which each of these wireless devices may communicate with each other without communicating via wireless access point 110a. Additionally, wireless devices 125g, 125h, and 125i are each members of NAN cluster 115b. As discussed herein, the NAN clusters shown in FIG. 1 comprise clusters of stations. Accordingly, reference to NAN clusters or clusters in the disclosure are intended to equate to clusters of stations. Thus, discussion of one of NAN clusters and clusters of stations is to refer to both NAN clusters and clusters of stations. These three wireless devices may communicate with each other even though they do not share wireless access points. Similarly, wireless devices 125e and 125f are each members of NAN 115c and may communicate with each other via NAN 115c even though they do not share a common wireless access point.

NAN clusters 115a-c represent communication networks among wireless devices 125a-j in close proximity. The NAN clusters 115a-c allow wireless devices 125a-j that may not share the same network infrastructure but that are geographically close to communicate which other in a more efficient manner than over the wireless networks 105a-c. The NAN clusters 115a-c focus on two-way communications between wireless devices, allowing wireless devices in close proximity to communicate with each other without having to go through the wireless networks 105a-c. Similarly, NAN clusters 115a-c allow their respective wireless devices that do share a wireless network 105a-c to communicate with each other without utilizing the inefficient communication path of wireless network 105a-c through the wireless access point 110a-c and instead communicate directly with each other. Additionally, NAN clusters 115a-c allow communication between their respective wireless devices that do not belong to wireless networks 105a-c, for example wireless device 125f. NAN cluster 115c may allow wireless device 125f to communicate with wireless device 125e even though wireless device 125f is not connected to any wireless network 105a-c.

Server 120, as discussed above, may not belong to any of wireless networks 105a-c or NAN clusters 115a-c. However, server 120 may independently communicate with each of wireless devices 125a-j and wireless access points 110a-c (not shown). The communications between the server 120 and wireless devices 125a-j or wireless access points 110a-c may be via any available link (i.e., Wi-Fi or cellular). Such independent communication may allow the server 120 to be aware of all clusters to which any wireless device 125a-j belongs (NAN clusters 115a-c). For example, server 120 may represent a download server for a particular service which may be utilized by all wireless devices 125a-j and wireless access points 110a-c independent of associations with specific wireless networks 105a-c. Such operation may make server 120 the most informed piece of equipment in wireless network system 100 with regards to details of the wireless devices 125a-j, wireless access points 110a-c, wireless networks 105a-c and NAN clusters 115a-c.

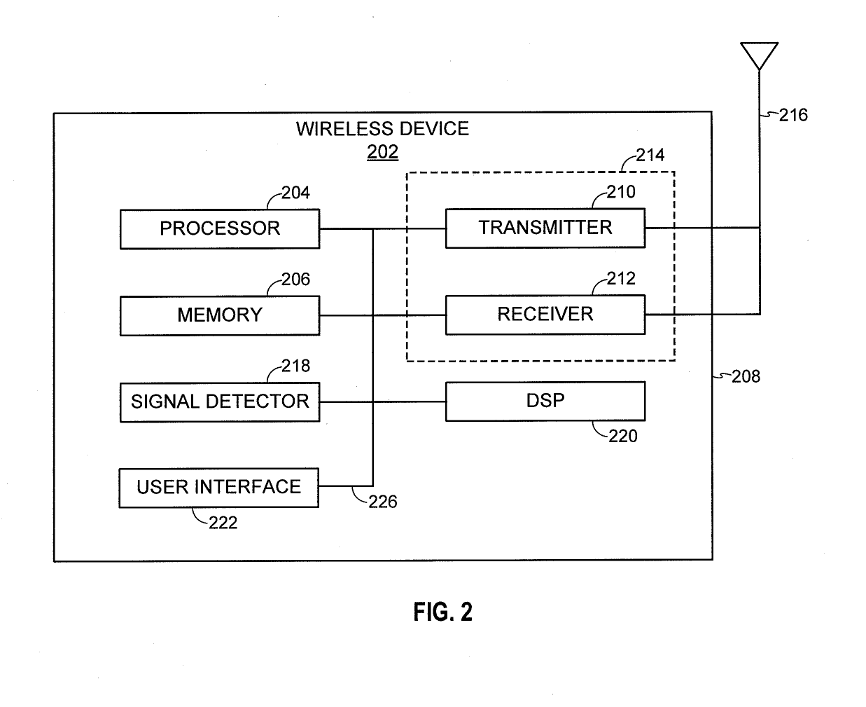

FIG. 2 illustrates various components that may be utilized in a wireless device 202 that may be employed within the wireless communication system 100. The wireless device 202 is an example of a device that may be configured to implement the various methods described herein. For example, the wireless device 202 may comprise the access point 105, or one of wireless devices 110a-110b, or one of wireless devices 115a-115c, for example.

The wireless device 202 may include a processor 204 which controls operation of the wireless device 202. The processor 204 may also be referred to as a central processing unit (CPU), a hardware processor, or a processing system. Memory 206, which may include both read-only memory (ROM) and random access memory (RAM), provides instructions and data to the processor 204. A portion of the memory 206 may also include non-volatile random access memory (NVRAM). The processor 204 performs logical and arithmetic operations based on program instructions stored within the memory 206. The instructions in the memory 206 may be executable to implement the methods described herein.

The processor 204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include non-transitory computer-readable medium comprising code that, when executed, causes an apparatus to perform one or more steps associated with one or more methods for modifying relay operation of a relay-compatible wireless device. Code may include source code format, binary code format, executable code format, or any other suitable format of code. The code, or instructions, when executed by one or more processors, causes the processing system to perform the various functions described herein.

The wireless device 202 may also include a transmitter 210 and a receiver 212 to allow transmission and reception of data between the wireless device 202 and a remote location. Further, the transmitters 210 and the receiver 212 may be configured to allow transmission and reception of setup and/or configuration packets or frames between the wireless device 202 and a remote location including, for example, an AP, a relay device, or an STA. The transmitter 210 and receiver 212 may be combined into a transceiver 214. An antenna 216 may be attached to the housing 208 and electrically coupled to the transceiver 214. Alternatively, or additionally, the wireless device 202 may include an antenna 216 formed as part of the housing 208 or may be an internal antenna. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals. The DSP 220 may be configured to generate a data unit for transmission. In some aspects, the data unit may comprise a physical layer data unit (PPDU). In some aspects, the PPDU is referred to as a packet or a frame.

The wireless device 202 may further comprise a user interface 222 in some aspects. The user interface 222 may comprise a keypad, a microphone, a speaker, and/or a display. The user interface 222 may include any element or component that conveys information to a user of the wireless device 202 and/or receives input from the user.

The various components of the wireless device 202 may be housed within a housing 208. Further, the various components of the wireless device 202 may be coupled together by a bus system 226. The bus system 226 may include a data bus, for example, as well as a power bus, a control signal bus, and a status signal bus in addition to the data bus. Those of skill in the art will appreciate the components of the wireless device 202 may be coupled together, or may accept or provide inputs to each other using some other mechanism.

Although a number of separate components are illustrated in FIG. 2, those of skill in the art will recognize that one or more of the components may be combined or commonly implemented. For example, the processor 204 may be used to implement not only the functionality described above with respect to the processor 204, but also to implement the functionality described above with respect to the signal detector 218 and/or the DSP 220. Further, each of the components illustrated in FIG. 2 may be implemented using a plurality of separate elements.

Server aided cluster merging may take any of multiple forms. In operation, a wireless, device currently a member of a cluster may periodically scan outside its own discovery windows (DWs) to determine if there exists a neighboring cluster with a better cluster grade than its current cluster or if a neighboring cluster with a better cluster grade is identified. Such period scanning may cause the wireless device to expend additional energy to discover a cluster with a better cluster grade. Similarly, should the wireless device find a cluster with a better cluster grade and join it, the wireless device may consume additional energy to advertise the cluster with the better grade to other wireless devices in the cluster from which the wireless device merged. Wireless devices should merge to a cluster with a better cluster grade if they are able to do so. A cluster grade may be determined using various cluster metrics, including, but not limited to, cluster age (where older clusters may have better grades), cluster size (more devices may have better grades), number of available services in the cluster (more available services may mean better grades), or master preference of an anchor master device, which may be indicated in discovery and/or synchronization beacons and/or frames. In some embodiments, the cluster grade may refer to a ranking of clusters of stations, such that a high cluster grade is associated with a cluster of stations that is preferred over clusters of stations having low cluster grades.

The above listing is meant to be exemplary and not limiting. The determination of a cluster grade is exemplary in the embodiments below, and is not meant to be limiting. Determination of a “better” neighboring cluster with which to merge may involve comparison of the number of services offered, or number of devices therein, or age, among others. In some embodiments, a cluster with a better cluster grade than the current cluster may comprise a cluster that is preferred over the current cluster. For example, a cluster have an older cluster age may be preferred over a cluster having a younger cluster age. If the server identifies a cluster of stations with an older cluster age than the current cluster of stations, then the identified cluster of stations may be preferred over the current cluster of stations by the wireless device. Similarly, a cluster of stations having a larger cluster size (for example, having a larger number of devices as part of the cluster) may be preferred over a cluster having a smaller cluster size. If the server identifies a cluster of stations with a larger cluster size than the current cluster of stations, then the identified cluster of stations may be preferred over the current cluster of stations by the wireless device. A cluster of stations having a more available services may be preferred over a cluster of stations with fewer available services. If the server identifies a cluster of stations with a larger number of services available than the current cluster of stations, then the identified cluster of stations with the larger number of services available may be preferred over the current cluster of stations by the wireless device. Additionally, the preferred cluster of stations or better cluster grade for a cluster of stations may vary dependent upon the wireless device; for example, for some wireless devices, the number of services available on the cluster of stations may be more important than the age of the cluster or the number of stations in the cluster. Accordingly, the request for these wireless devices may place more importance on the number of services than the other factors. The embodiments below discussing neighboring clusters with better cluster grades is exemplary and not meant to be limiting of what is a better neighboring cluster and how a better neighboring cluster is determined.

In one embodiment, server aided cluster merging may indicate a method where the server aids in cluster merging. In such an embodiment, a wireless device may not periodically scan outside its own discovery windows in search of a neighboring cluster with a better cluster grade than its current cluster. A neighboring cluster may be a cluster in close proximity to the wireless device. A neighboring cluster may also be a cluster in close proximity to the wireless device with which the wireless device is capable of communicating. Instead, the wireless device may request a server to inform it whenever a neighboring cluster with a better cluster grade exists. In an embodiment, such a request may require the wireless device to disclose to the server its location, cluster identification, and cluster grade. In another embodiment, such a request may require the wireless device to disclose other cluster metrics and proximity information. Thereafter, the server may search for a neighboring cluster with a better cluster grade. In an embodiment, the searching may include active searching via communications with all wireless devices with which the server is connected. In another embodiment, the server may search based on stored cluster information. If the server's search reveals a cluster with a better cluster grade, the server may inform the requesting wireless device that a cluster with a better cluster grade is in the wireless device's range. The server may provide information including the neighboring cluster's channel or discovery window or beaconing information. If the wireless device is able to hear a beacon from the neighboring cluster with a better cluster grade (for example, the wireless device is within communication range of the neighboring cluster with the better cluster grade), the wireless device may merge to the neighboring cluster. The wireless device may merge with the neighboring cluster with the better cluster grade if the wireless device determines that the neighboring cluster is preferred over the cluster to which the wireless device currently belongs. Thereafter, in an embodiment, the wireless device may advertise to other members of the cluster the wireless device just left of the existence of a neighboring cluster with a better cluster grade to allow them to merge with the neighboring cluster as well.

In an alternate embodiment, server aided cluster merging may indicate a method where the server manages cluster merging. In such an embodiment, the steps referenced above regarding the search request to the server may still occur. Similarly, the server may perform similar steps in performing the searches and informing the wireless device of the existence of a neighboring cluster with a better cluster grade. However, instead of merely aiding wireless devices to merge individually to the neighboring cluster, the server may request all devices in a cluster to merge to a neighboring cluster with a better grade if the server knows the clusters are overlapped. In an embodiment, two or more clusters may be overlapped if at least two wireless devices from each cluster are in range of at least two wireless devices from another cluster. This embodiment speeds up cluster merging compared to server aided cluster merging discussed above.

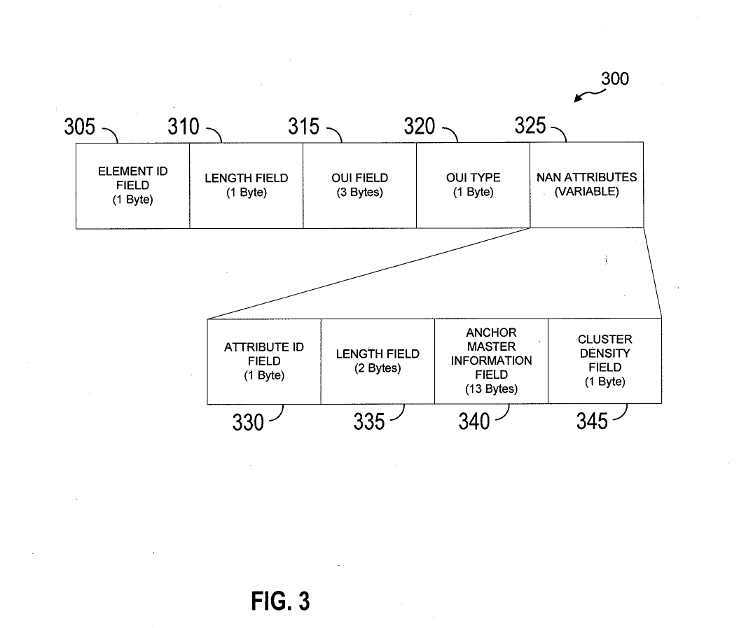

FIG. 3 shows a message frame that may be used for communicating cluster information in either the cluster search request or cluster search response in one implementation. Specifically, FIG. 3 shows an embodiment of a NAN information element (IE) 300 for communicating cluster attributes of a wireless device to another wireless device. Those skilled in the art will appreciate that the NAN IE 300 may have more or fewer components than illustrated in FIG. 3. As shown, the NAN IE 300 includes a sampling of components useful for describing some prominent features of implementations within the scope of the claims and may include one or more additional fields that are not shown or may include one or more fields that may not be utilized in all embodiments. The NAN IE 300 includes element ID field 305, which may be 1 byte in length for example, and may include an integer value identifying the specific NAN IE. The NAN IE 300 may further include a length field 310, which may also be 1 byte in length, and which may include an integer value indicating length, in octets, of the following fields in the NAN IE 300. The value of the NAN IE 300 depicted, for example, may be 4 plus the total length of the NAN attributes. The NAN IE may further include an Organizationally Unique Identifier (OUI) field 315, which may be 3 bytes in length, and may include an integer value representing a Wi-Fi Alliance (WFA) specific OUI. The NAN IE 300 may further include an OUI type field 320, which may be 1 byte in length, and may include a value identifying the type and version of the NAN IE 300. The NAN IE 300 may further include a NAN Attributes field 325, which may be of variable length and may contain NAN attributes therein.

As shown in FIG. 3, NAN attributes 325, which may be contained within NAN IE 300, may be formatted consistent to a common general format to contain a 1 byte NAN attribute ID field 330, a 2 byte length field, and a variable-length attribute specific information fields. This general format may apply to a cluster attribute. The cluster attribute format which may be contained in the NAN attributes field 325 of NAN IE 300 may include attribute ID field, which may be 1 byte in length, which may contain a value of “1” indicating the type of NAN attribute being a cluster attribute. The cluster attribute may also include a length field 335 of 2 bytes, which may include an integer value indicating the length of the fields following in the attribute. The cluster attribute may include an anchor master information field 340 of 13 bytes which may indicate information about the cluster's anchor master. The cluster attribute may also include a cluster density field 345 of length 1 byte which may include the number of NAN devices in the NAN cluster. Additional fields (not shown), including but not limited to requesting device location, cluster grade, cluster age, or cluster services available may be included in the cluster attribute field of NAN attributes 325. Additionally, the structure of the cluster attributes of the NAN attribute field 325 may be formatted such that the most important metric for determining cluster ranking is located in a specific location in the attribute. For example, if the device sending the NAN IE 300 believes the cluster grade is the most important field to be used in searching for neighboring clusters, then the cluster grade may be the first field in the cluster attributes. In another embodiment, if the device sending the NAN IE 300 believes the cluster density field 345 is the is the most important field to be used in searching, then the cluster density field 345 may be the first field in the cluster attributes.

In an embodiment, the NAN attributes 325 of NAN IE 300 may include specific information in a cluster search response. A device responding to a cluster search request with cluster information of a better neighboring NAN cluster may include a field for the discovery window schedule (not shown) of the neighboring cluster and a field for the operating channel number (not shown) of the neighboring cluster.

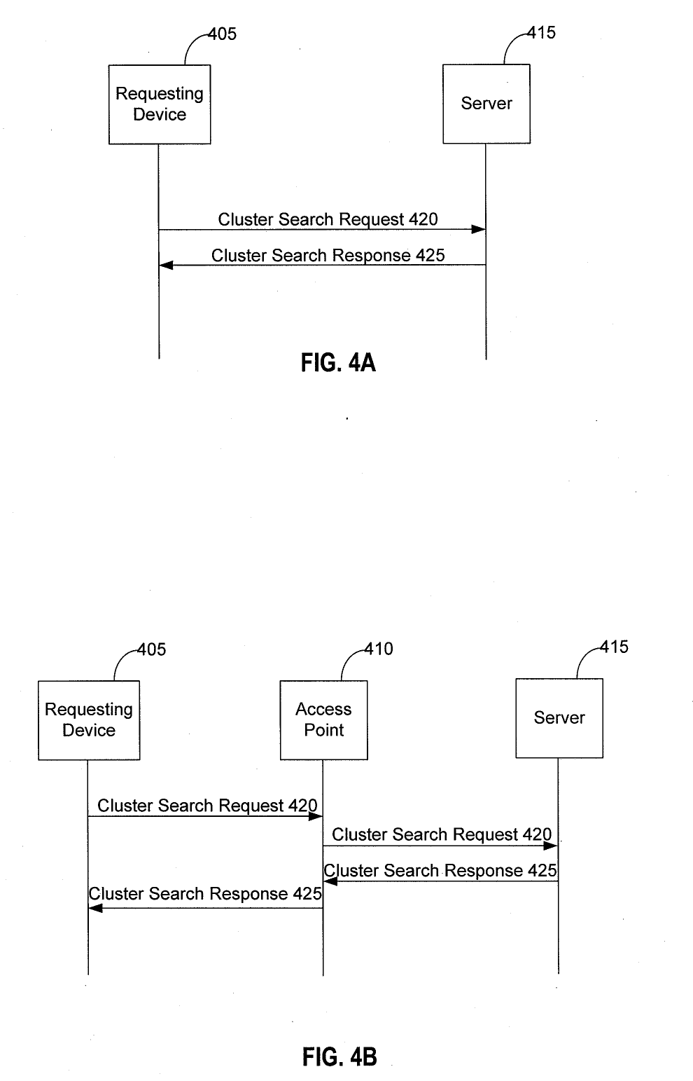

FIG. 4A is a call flow diagram of a method for requesting a cluster search between a requesting device and a server, in accordance with one implementation, and generally designated 400a. FIG. 4A shows two devices. In one embodiment, these devices may be a requesting device 405 (i.e., one of wireless device 125a-j or wireless access points 110a-c) and a server 415 (i.e., server 120). In one embodiment, the cluster search process may begin with the determination (not shown) that the requesting device 405 wants to join a cluster with a better cluster grade than the cluster of which it is currently a member. The requesting device 405 may generate (not shown) a message (i.e., NAN IE 300 in FIG. 3) containing the specifics of the NAN cluster to which requesting device 405 currently belongs, if any, to send to server 415. The next step is the cluster search request 420 being sent from the requesting device 405 to the server 415. The cluster search request 420 may include the NAN IE 300 generated by the requesting device 405 requesting that the server 415 search for a neighboring cluster requesting device 405 can join that has a better cluster grade than that indicated in the NAN IE 300 sent to server 415 in the cluster search request 420. For example, the request device 405 (i.e., wireless device 125b) currently a member of a NAN cluster (i.e., NAN cluster 115a) with 3 other wireless devices (i.e., 125a, 125c, and 125d) on which one service is offered may send server 415 (i.e., server 120) a cluster search request 420 requesting server 415 search for a neighboring cluster with more than 4 wireless devices and/or with more than one service being offered with which requesting device 405 (wireless device 125b) can merge. In an embodiment, NAN IE 300 contained in the cluster search request 420 may indicate a ranking of variables or metrics according to which requesting device 405 wants server 415 to search. For example, requesting device 405 may use NAN IE 300 in cluster search request 420 to indicate that requesting device 405 is more concerned with the number of services available in the cluster or the number of wireless devices in the cluster as opposed to the age of the cluster. Alternatively, requesting device 405 may not indicate what metric is most important to it and instead server 415 may determine what metrics are most important in determining cluster grades. In some embodiments, such cluster grade hierarchy may be established as a standard or by a node manufacturer, or a user, for example the master preference of anchor master device may be established as meaning a cluster with a higher master preference has a higher cluster grade.

In another embodiment, requesting device 405 may generate a NAN IE 300 for cluster search request 420 before it is a member of a NAN cluster. In such a communication, requesting device 405 may request from the server 415 the best neighboring cluster which it is possible for the requesting device 405 to merge with. As discussed above, in an embodiment, the requesting device may provide in its cluster search request 420 the metrics it views as being most important in the cluster grade search. In other embodiments, as discussed above, the requesting device 405 may not provide insight into the cluster grading process and leave such determination to the server 415. After submitting the cluster search request 420 to the server 415, requesting device 405 may wait for a response from the server 415. In an embodiment, the wireless device 125 may submit a cluster search request 420 before it has joined a cluster. The wireless device 125a may request, in the cluster search request 420, for the server 120 to indicate the best cluster available for the wireless device 125a to join. In an alternate embodiment, the wireless device 125a may request, in the cluster search request 420, for the server 120 to indicate all potential clusters available for wireless device 125a to join. In an embodiment, the cluster search request 420 may not include the same information in NAN IE 300 as would be in a cluster search request 420 from a wireless device already a member of a cluster. For example, the search request 420 may not include the cluster identification, grade, or other metrics regarding the cluster if it does not belong to a cluster at the time the cluster search request 420 is sent to server 120. However, the cluster search request 420 may still include the wireless device location. In an alternate embodiment, the wireless device 125a may send the cluster search request 420 to the server 120 upon joining a cluster. In another embodiment, the wireless device 125a may send the cluster search request 420 to the server 120 in a periodic fashion after joining a cluster. Such a search request may allow the wireless device to periodically monitor the current conditions to see if there is a cluster with a better cluster grade. In some other embodiments, the wireless device 125a may submit a cluster search request 420 to the server 120 whenever the wireless device 125a significantly changes its geographic location, for example the wireless device 125a leaves or enters the coverage area of an access point or changes location substantially (by more than a few meters).

The server 415 may perform the search of other neighboring clusters and provide a cluster search response 425 to the requesting device 405. In some embodiments, a server 415 may only provide a cluster search response 425 when the search performed results in the determination that a neighboring cluster with a better grade than that of the requesting device is found. The resulting cluster search response 425 may contain information that may help a requesting device 405 merge with the neighboring cluster with a better cluster grade. This information may include, but is not limited to, the neighboring cluster's ID, grade, metrics, discovery window schedule, or operating channel number.

In an embodiment, server 415 may receive a cluster search request 420 from requesting device 405. When the requesting device 405 is not currently a member of a NAN cluster and thus cannot be compared to neighboring clusters, server 415 may search for the best cluster in the proximity of the requesting device 405 according to preferences established (i.e., by the server, requesting device, user, manufacturer, or standards). The server 415 may search for neighboring clusters with better cluster grades based by searching stored cluster information or by sending inquiries to access points and other devices near the requesting device 415. To search stored cluster information, the server 415 may store cluster information from all devices it has communicated or interacted with in order to have the proper information to search when a cluster search request 420 is received. In an alternate embodiment, the server 415 may instead submit inquiries or a similar message to access points and other wireless devices in the proximity of requesting device 405 requesting cluster information for any clusters they are aware of or to which they or their devices may belong. The access points and devices server 415 communicates with in its search for a neighboring cluster may utilize the same options of searching stored cluster information or communicating with devices to determine the existence of a neighboring cluster with a better cluster grade in the requesting device 405 proximity. A better cluster may exist if there is a neighbor device to the requesting device 405 in a different cluster with a better cluster grade in proximity to the requesting device 405. A neighbor access point may be determined by the distance between the neighbor access point and the requesting device 405. If the distance between the two is less than a threshold distance, then the neighbor access point may be in the proximity of the requesting device 405. In another embodiment, proximity of a neighbor access point to the requesting device 405 may be determined by the strength of the signal the requesting device receives from the neighbor access point. For example, a requesting device 405 may receive communications from multiple neighbor access points, where the signal from each neighbor access point is a different strength. Thus, the strength of the signal from the neighbor access point may correlate to the distance between the neighbor access point and the requested device 405. A neighbor device can determine that it is in proximity to the requesting device if the distance between both devices is less than a threshold or they observe the same nearest/strongest access point. The request sent by the requesting device contains its location info, which can be its GPS coordinates or observed nearest/strongest access point GPS coordinates or identification. The location info is further relayed to each neighbor device via the server and selected inquiring access points. If the server 415 learns of the existence of a neighboring cluster with a better cluster grade, either from searching stored cluster information or from inquiring with access points or another means, the server 415 will generate and transmit a cluster search response 425 to send to the requesting device 405.

In some other embodiments, the server 415 may request all devices in a cluster to merge with a neighboring cluster with a better cluster grade if the server 415 is aware the clusters are overlapped. Such an embodiment may provide for a more efficient method of merging clusters. As discussed below, clusters may be overlapped if at least two devices from both clusters are in each other's range. For example, two clusters may be overlapped if two devices from both clusters can hear beacons from the other cluster. In some other embodiment, the server 415 may detect that one cluster is overlapped with a neighboring cluster with a better cluster grade by being informed by a requesting device that successfully merges from one cluster to a neighboring cluster. If two devices merge between two clusters, then the two clusters may be overlapped. In another embodiment, the server 415 may predict two clusters are overlapped based on stored device location and cluster information, where the server 415 may determine that at least two devices from two clusters are in close proximity to each other. For example, the server 415 may detect from store information that two devices from one cluster are 2 meters from two devices from a second cluster, and that there is likely a high probability that they are overlapped. If the server 415 determines there are clusters that are overlapped, the server may request that all devices in one cluster merge into the neighboring cluster with a better cluster grade. In one embodiment, this request may involve server 415 sending the cluster information for the neighboring cluster with a better cluster grade to the devices in the other cluster. Thereafter, the devices in the other cluster may synchronize their merging with the neighboring cluster by simultaneously tuning to the discovery windows and operating channel of the neighboring cluster. In another embodiment, the server may send a request to all devices in the other cluster to change their discovery window and channel to match that of the neighboring cluster as opposed to allowing the devices to scan and merge themselves. In the request, the server can specify the common time to change those configurations for synchronized merging operation across devices.

In another embodiment, as depicted in FIG. 4B, an access point 410 may serve as an intermediary between requesting device 405 and server 415. In an embodiment, requesting device 405 may send cluster search request 420 to access point 410 to then submit to server 415. Server 415 may then generate a cluster search response 425 to send to access point 410, which then may send the cluster search response 425 to requesting device 405. In another embodiment, an access point 410 may serve as a proxy for the requesting device 405. The access point 410 may be requested by the requesting device 405 to serve as a proxy, or in some embodiments, the access point 410 may automatically act as a proxy for requesting device 405. In an embodiment, the access point 410 may send the cluster search requests 420 to server 415 and receive cluster search responses 425 from server 415 on behalf of the requesting device 405, allowing the requesting device 405 to conserve power. In an embodiment, the access point 410 may collect the device location, or alternatively use its own location, the cluster identification of the requesting device, the requesting device's current cluster grade, and any additional metrics. If the access point uses its own location as the device location, the own location can be represented by the access point's GPS coordinates or ID, e.g. MAC address. The access point 410 may collect this information upon association or whenever it detects that this information has changed once the requesting device 405 is associated with access point 410. Access point 410 may obtain information regarding the NAN cluster of the requesting device 405 by monitoring NAN beacons send by the requesting device 405.

Based on the information access point 410 collects regarding requesting device 405 and its current cluster, access point 410 may generate and send a cluster search request 420 to the server 415 on behalf of requesting device 405. The access point 410 may send cluster search requests 420 to server 415 periodically or whenever the cluster information of requesting device 405 changes, e.g. cluster grade and metrics. Access point 410 may inform requesting device 405 if it receives a cluster search response 425 from the server 415 or whenever a better cluster is found as indicated in the response. Access point 410 may send the cluster search response 425 directly to requesting device 405.

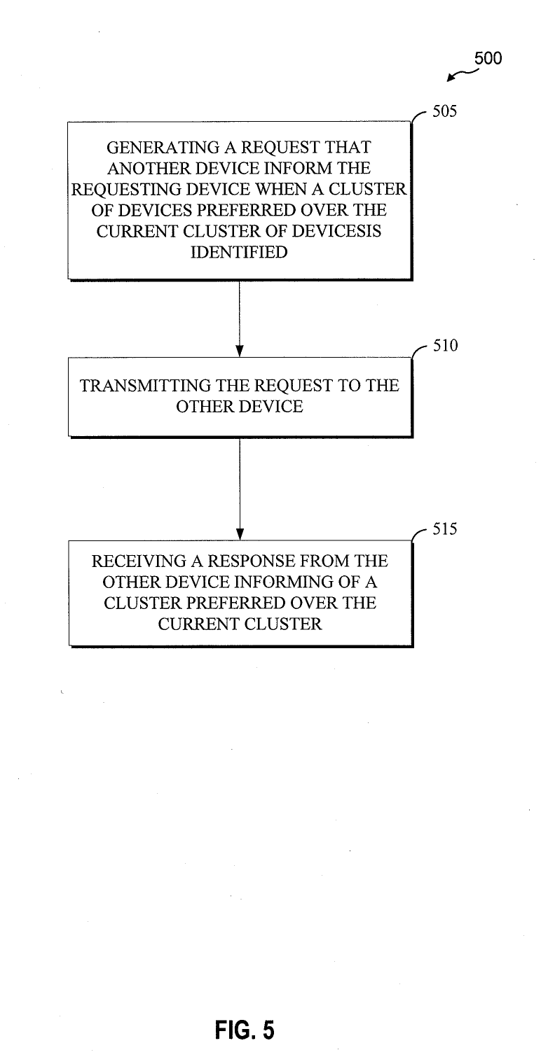

FIG. 5 refers to a flowchart of a method 500 for requesting another device to search for and inform the requesting device of a neighboring cluster with a better cluster grade, in accordance with one implementation. In an embodiment, a wireless device, for example wireless device 125a, may perform the method 500. In block 505, the requesting device may generate a request to device server or access point to inform the requesting device (for example, a station) when a cluster of stations is preferred over the current cluster of stations to which the device currently belongs exists (or is identified). The request of block 505 of method 500 may correspond to the cluster search request 420. The cluster search request 420 may include a NAN IE 300, as discussed in FIG. 3, structured to include, but is not limited to, the location of the requesting device 405, the cluster identification (ID), the cluster grade, the cluster size, the cluster age, or other cluster metrics associated with the cluster requesting device 405 currently belongs to, if any. In some embodiments, the cluster search request 420 from requesting device 405 may comprise a layer 3 message to the requested server 415. The NAN IE 300 may include a time for the server 120 to submit a response to the wireless device 125a. In some embodiments, this time may indicate a request for an immediate response. In other embodiments, this time may indicate the server should only respond whenever a potential cluster with a better cluster grade is found. The contents of the cluster search request 420 may also be dependent upon the current status of the requesting device 405. If the requesting device 405 is currently not a member of a NAN cluster, the cluster search request 420 may not include information regarding a current cluster and the associated metrics, instead only including the location of the requesting device (or the location of the wireless access point). In another embodiment, the requesting device 405 not a member of a NAN cluster may include in its cluster search request 420 the cluster metrics it is looking for in a neighboring NAN cluster. In some other embodiments where the requesting device 405 has just joined a NAN cluster or is just periodically searching or has changed location significantly, the cluster search request 420 may include information regarding the cluster the requesting device 405 currently belongs to.

In block 510, the requesting device 405 (a station) may transmit the search request generated in block 505 to the server or the access point (or another device). For example, wireless device 125a may send a cluster search request 420 to a server 415, for example server 120. In block 515, the requesting device 405 (the station) may receive a cluster search response 425 from the server 415 informing the requesting device 405 of a cluster of stations that is preferred over the cluster of stations to which the requesting device 405 (the station) currently belongs. In other embodiments where requesting device 405 does not currently belong to a NAN cluster, the cluster search response 425 may indicate the best cluster available to join or may indicate all of the clusters available to join in the proximity of the requesting device 405. The response received in block 515 may be cluster search response 425. The cluster search response 425 may include a NAN IE 300 structured to contain the information necessary to facilitate requesting device 405 merging with the neighboring cluster found. This information may include the cluster identification, channel, discovery window schedule, and information related to beacons.

In some embodiments, the requesting device 405 may scan for and attempt to merge with the neighboring cluster. The requesting device 405 may use information received in cluster search response 425 to scan for the neighboring cluster beacon. If the requesting device 405 is able to see the beacon from the cluster, then the requesting device may merge with the neighboring cluster.

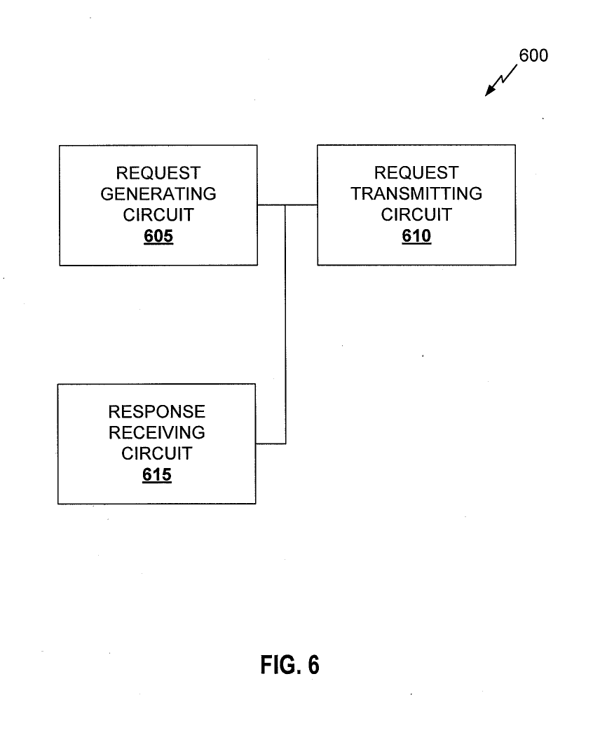

FIG. 6 is a functional block diagram of an exemplary device 600 that may be employed within the wireless communication system 100. The device 600 comprises a request generating circuit 605, a request transmitting circuit 610, a response receiving circuit 615, and scanning and merging circuit 620. The request generating circuit 605 may be configured to perform one or more of the functions discussed above with respect to the block 505 illustrated in FIG. 6. The request generating circuit 605 may correspond to one or more of the processor 204, the memory 206, or the user interface 222 depicted in FIG. 2. In some aspects, means for generating a request that another device inform the requesting device when a neighboring cluster with a better cluster grade is identified may include the request generating circuit 605.

The request transmitting circuit 610 may be configured to perform one or more of the functions discussed above with respect to block 510 illustrated in FIG. 5. The requesting transmitting circuit 610 may correspond to one or more of the processor 204, memory 206, the transmitter 210, or the transceiver 214 of FIG. 2. In some other aspects, a means for transmitting the request to the other device may include the request transmitting circuit 610.

The response receiving circuit 615 may be configured to perform one or more of the functions discussed above with respect to block 515 illustrated in FIG. 5. The response receiving circuit 615 may correspond to one or more of the processor 204, the transmitter 210, or the transceiver 214. In some aspects, a means for receiving a response from the other device informing of a neighboring cluster with a better cluster grade may include the response receiving circuit 615.

In some embodiments, an additional circuit for scanning and merging may exist. The scanning and merging circuit may be configured to perform one or more of the scanning and merging functions discussed above. The scanning and merging circuit may correspond to one or more of the processor 204, the transmitter 210, the receiver 212, the user interface 222, or the transceiver 214. In some aspects, a means for scanning for and merging with the neighboring cluster may include the scanning and merging circuit.

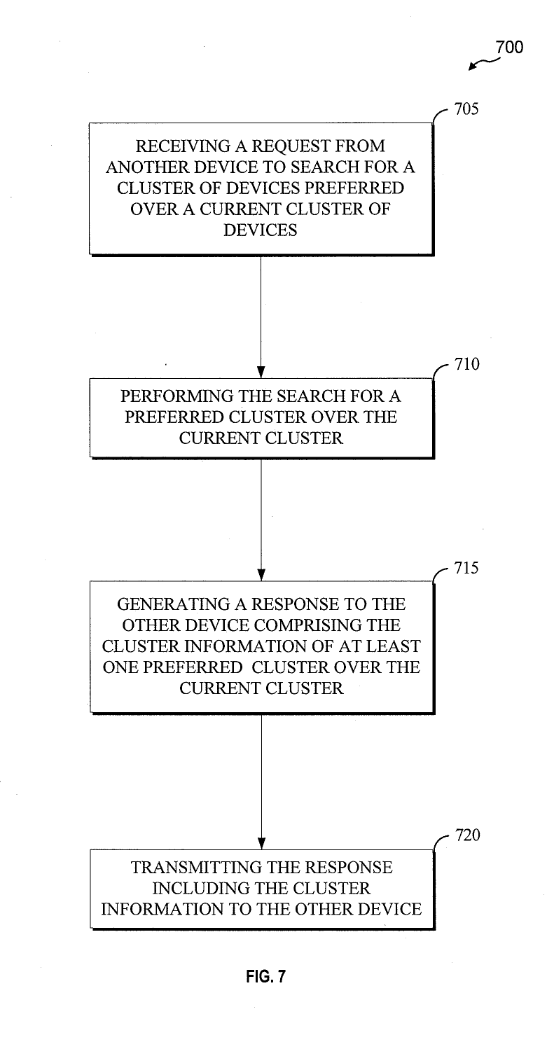

FIG. 7 is a flowchart of a method for a server to receive a request from a device (an access point or a station) to search for and inform it of a cluster of stations that is preferred over the current cluster of stations to which the device belongs, in accordance with one implementation. In an embodiment, a server, for example server 120, may perform the method 700. As indicated in block 705, server 120 may receive a cluster search request 420 from a wireless device (a station or access point), for example wireless device 125a. In an alternate embodiment, the cluster search request 420 received may be sent by wireless access point 110a on behalf of wireless device 125a, as noted in FIG. 4B. As discussed in FIG. 3, the request may include a NAN IE 300 structured to include, but not limited to, the wireless device 125a location, current cluster identification, current cluster grade, cluster size, cluster age, or other cluster metrics associated with the cluster of stations. In another embodiment, the NAN IE 300 may not include the wireless device 125a location, but rather the location of the access point 110a that is located nearest the wireless device 125a.

As indicated by block 710, the server 120 may perform the search for the preferred cluster of stations. In an embodiment, the search for the preferred cluster of stations may entail the server 120 searching stored cluster information for potential clusters of stations that are preferred over the current cluster of stations. Such a search may require the server 120 to store cluster information for all wireless devices with which it interacts and communicates. The cluster information stored may include all the metrics discussed above, including, but not limited to cluster identification, cluster location in relation to wireless device location (i.e., GPS coordinates or a neighbor access point identification or coordinates, where neighbor access point can be the nearest one or the one with strongest received signal strength), cluster size, cluster age, cluster grade, cluster discovery window schedule, cluster channel number, services available, and other metrics associated with the clusters of stations. This information may be acquired via direct communication with individual wireless devices, for example wireless device 125a. In some embodiments, this information may be acquired from communication with wireless access points, for example, wireless access point 110a. Wireless access point 110a may then provide server 120 with the cluster information for all wireless devices with which access point 110a associates and communicates and of which access point 110a is aware. The access point 110a and/or the wireless device 125a may upload the respective information to the stored information of the server 120. This embodiment may require additional storage overhead but may result in quicker responses to the cluster search requests, and thus may be useful in embodiments where the cluster search request includes a request for an immediate response.

In some other embodiment, the search for a cluster with a better cluster grade may entail the server 120 communicating with wireless access points and wireless devices near the requesting device 405. In such a search, the server 120 may send inquiries or messages to neighboring access points, wireless devices, or other wireless devices to determine if a neighboring cluster with a better cluster grade exists. The inquiry may be sent to neighboring devices because the requesting device 405 may only be able to merge with a NAN cluster in its proximity (within a threshold distance from the requesting device 405) (i.e., the wireless device can hear the NAN cluster beacon). In some embodiments, the neighboring devices will be determined as having a distance within a threshold of the requesting device 405. The inquiry sent may include the location information of the requesting device 405, the location information of the access point nearest the requesting node, metrics regarding the cluster to which the requesting device 405 currently belongs, or the cluster grade of the requesting device 405 current cluster. In an embodiment, when the server 120 sends an inquiry to a wireless access point or other wireless device to determine if a neighboring cluster with a better cluster grade exists (or is identified), the access point or wireless device searches for a neighboring cluster with a better cluster grade in its coverage. As discussed above with regards to the server 120 search, the wireless access point search may entail a search of stored cluster information of devices within its coverage. Additionally, as in the discussion above, the wireless access point may search for a cluster with a better cluster grade by sending inquiries or messages to devices within its coverage area requesting a response if one of the inquired devices has a better cluster grade and if the wireless access point determines the inquired devices are in close proximity to the original requesting wireless device (thus capable of being merged into). The inquired device is in close proximity to the requesting device if the distance from the inquired device to the requesting device is less than a threshold. If the wireless access point receives a response to an inquiry or message indicating a neighboring cluster with a better cluster grade or finds a neighboring cluster with a better cluster grade in its stored cluster information, the wireless access point may report the response to the server 120. The response may include information necessary to merge with the identified neighboring cluster, including, but not limited to, cluster channel, cluster identification, cluster discovery window time schedule, cluster grade, and cluster metrics. The cluster channel may comprise what channel the cluster is communicating on and on which channel the discovery window is broadcast. The cluster identification may be a unique identifier for a specific cluster. The cluster discovery window time schedule may include the periodic intervals for the cluster discovery window, informing of when synchronization information is communicated. The cluster grade may include the grade of the neighbor cluster, and cluster metrics may include any other metrics determined to be important.

In an embodiment, upon discovery of a neighboring cluster with a better cluster grade than that of the requesting device 405, the server 120 may generate a response to the requesting device 405 (the station or access point), as indicated by block 715. As discussed above, the response may include information necessary to facilitate merging with the identified, preferred cluster. In an embodiment, if multiple preferred clusters of stations are found, the server may generate a response including information for each of the identified preferred clusters of stations found. In another embodiment, the server may only generate a response including information for a single preferred cluster of stations, the single preferred cluster of stations selected by the server. This selection may be based upon the cluster grade (i.e., the cluster with the best cluster grade is selected), or proximity (i.e., the cluster in closest proximity to the requesting wireless device is selected), or any other cluster metric. As depicted in block 720, the response generated in block 715 is transmitted to the requesting device 405 (the station or the access point).

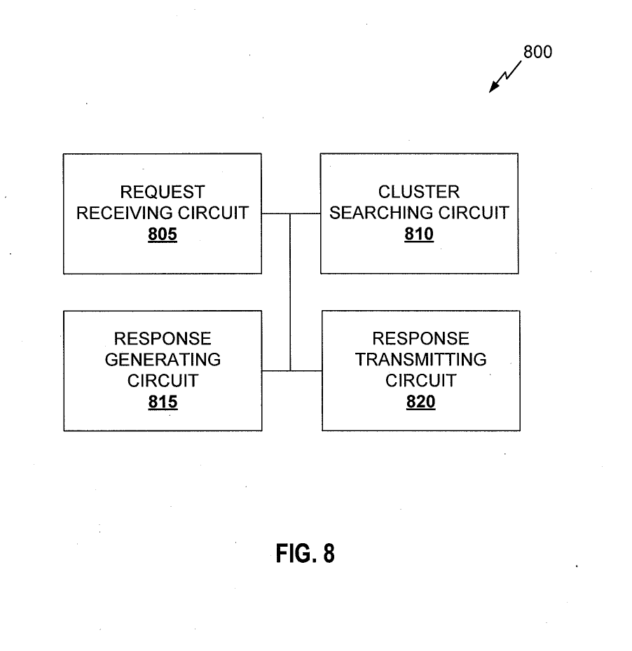

FIG. 8 is a functional block diagram of an exemplary wireless device 800 that may be employed within the wireless network system 100. The device 800 comprises a request receiving circuit 805. The request receiving circuit 805 may be configured to perform one or more of the functions discussed above with respect to the block 705 illustrated in FIG. 7. The request receiving circuit 805 may correspond to one or more of the receiver 212, the transceiver 214, and/or the processor 204. In some aspects, a means for receiving a request from another device to search for a neighboring cluster with a better cluster grade and inform the other device when such a neighboring cluster is found may comprise the request receiving circuit 805.

The device 800 further comprises a cluster searching circuit 810. The cluster searching circuit 810 may be configured to perform one or more of the functions discussed above with respect to block 710 illustrated in FIG. 7. The cluster searching circuit may correspond to one or more of the processor 204, the memory 206, the user interface 226, the receiver 212, the transceiver 214, and/or the transmitter 210. In some aspects, a means for performing the requested search may comprise the cluster searching circuit 810.

The device 800 further comprises a response generating circuit 815. The response generating circuit 815 may be configured to perform one or more of the functions discussed above with respect to block 715 shown in FIG. 7. The response generating circuit 815 may correspond to one or more of the processor 204, the transmitter 210, the transceiver 214, or the user interface 226. In some aspects, a means for generating a response to the other device informing of a neighboring cluster with a better cluster grade may comprise the response generating circuit 815.

The device 800 further comprises a response transmitting circuit 820. The response transmitting circuit 820 may be configured to perform one or more of the functions discussed above with respect to block 720 illustrated in FIG. 7. The response transmitting circuit 820 may correspond to one or more of the processor 204, the transmitter 210, or the transceiver 214. In some aspects, a means for transmitting the response to the other device may comprise the response transmitting circuit 820.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. An apparatus for merging a station between clusters of stations in a neighbor aware network, comprising:
a processing system configured to:
generate a request to a server on the network that the server to inform the station when a cluster of stations that is preferred over a current cluster of stations to which the station belongs is identified;
provide the generated request for transmission to the server; and
receive a response from the server, the response configured to identify the cluster of stations that is preferred over the current cluster of stations.

2. The apparatus of claim 1, the processing system further configured to scan the network for the cluster of stations identified by the server as being preferred over the current cluster of stations.

3. The apparatus of claim 1, the processing system further configured to merge the station with the cluster of stations identified by the server as being preferred over the current cluster of stations based on a determination that the station prefers the identified cluster of stations over the current cluster of stations.

4. The apparatus of claim 1, the generated request comprising at least one of: a location of the station, a cluster identification of the current cluster of stations, and one or more metrics associated with the current cluster of stations, wherein the generated request is configured to request from the server an identification of the preferred cluster of stations within a range of communication of the station.

5. The apparatus of claim 4, wherein the location of the station is provided by including at least one of an identification and GPS coordinates of an access point.

6. The apparatus of claim 5, wherein the access point is at least one of an access point associated with the current cluster of stations, and an access point having being discovered to be in a proximity of the station.

7. The apparatus of claim 1, the preferred cluster of stations being determined based on at least one of: a cluster age of the current cluster of stations as compared with a cluster age of the preferred cluster of stations, a cluster size of the current cluster of stations as compared with a cluster size of the preferred cluster of stations, a number of available services in the current cluster of stations as compared with a number of available services in the preferred cluster of stations, and a master preference of an anchor master device.

8. A method for a station to merge between clusters of stations in a neighbor aware network, comprising:
generating a request to a server on the network to inform the station when a cluster of stations that is preferred over a current cluster of stations to which the station belongs is identified;
transmitting the request to the server; and
receiving a response from the server, the response identifying the cluster of stations that is preferred over the current cluster of stations.

9. The method of claim 8, further comprising scanning the network for the cluster of stations identified by the server as being preferred over the current cluster of stations.

10. The method of claim 8, further comprising merging the station with the cluster of stations identified by the server as being preferred over the current cluster of stations based on a determination that the station prefers the identified cluster of stations over the current cluster of stations.

11. The method of claim 8, the generated request comprising at least one of: a location of the station, a cluster identification of the current cluster of stations, and metrics associated with the current cluster of stations, wherein the generated request is configured to request from the server an identification of the preferred cluster of stations within a range of communication of the station.

12. The method of claim 11, wherein the location of the station is provided by including at least one of an identification and GPS coordinates of an access point.

13. The method of claim 12, wherein the access point is at least one of an access point associated with the current cluster of stations and an access point having been discovered to be in a proximity of the station.

14. The method of claim 8, the preferred cluster of stations being determined based on at least one of: a cluster age of the current cluster of stations as compared with a cluster age of the preferred cluster of stations, a cluster size of the current cluster of stations as compared with a cluster size of the preferred cluster of stations, a number of available services in the current cluster of stations as compared with a number of available services in the preferred cluster of stations, and a master preference of an anchor master device.

15. An apparatus for a server to aid a first station to merge between clusters of stations in a neighbor aware network, comprising:
a processing system configured to:
receive a request from an access point on the network to perform a search for a cluster of stations that is preferred over a current cluster of stations identified by the access point;
perform the search for the cluster of stations that is preferred over the current cluster of stations;
generate a response to the access point, the response identifying the cluster of stations that is preferred over the current cluster of stations; and
provide the response for transmission to the access point.

16. The apparatus of claim 15, the received request comprising at least one of: a location of the access point, a cluster identification of the current cluster of stations, and one or more cluster metrics associated with the current cluster of stations, wherein the received request is configured to request from the server an identification of the preferred cluster of stations within a range of communication of the access point.

17. The apparatus of claim 16, wherein the access point is at least one of an access point associated with the current cluster of stations and an access point having been discovered to be in a proximity of the station.

18. The apparatus of claim 15, the response identifying the cluster of stations that is preferred over the current cluster of stations comprising at least one of: a location of the preferred cluster of stations, a cluster identification of the preferred cluster of stations, a discovery window schedule of the preferred cluster of stations, and an operating channel number of the preferred cluster of stations.

19. The apparatus of claim 15, the request received from the access point being based on information from the first station, the current cluster of stations identified by the access point being based on a current cluster of stations to which the first station belongs.

20. The apparatus of claim 15, the search for the preferred cluster of stations being based on clusters of stations information stored by the server.

21. The apparatus of claim 15, the search for the preferred cluster of stations further comprising:
sending at least one inquiry to at least one second station on the network; and
receiving at least one inquiry-response from the at least one second station.

22. The apparatus of claim 21, the inquiry including at least one of a location of the access point, a cluster identification of the current cluster of stations, and one or more cluster metrics associated with the current cluster of stations, and the at least one inquiry-response received from the at least one second station comprising at least one of: a location of the preferred cluster of stations, a cluster identification of the preferred cluster of stations, a discovery window schedule of the preferred cluster of stations, and an operating channel number of the preferred cluster of stations.

23. A method implemented by a server for aiding a first station to merge between clusters of stations in a neighbor aware network, comprising:
receiving a request from an access point on the network to perform a search for a cluster of stations that is preferred over a current cluster of stations identified by the access point;
performing the search for the cluster of stations that is preferred over the current cluster of stations;
generating a response to the access point, the response identifying the cluster of stations preferred over the current cluster of stations; and
transmitting the response to the access point.

24. The method of claim 23, the received request comprising at least one of: a location of the access point, a cluster identification of the current cluster of stations, and cluster metrics associated with the current cluster of stations, wherein the received request is configured to request from the server an identification of the preferred cluster of stations within a range of communication of the access point.

25. The method of claim 24, wherein the access point is at least one of an access point associated with the current cluster of stations and an access point having been discovered to be in a proximity of the station.

26. The method of claim 23, the response identifying the cluster of stations that is preferred over the current cluster of stations comprising at least one of: a location of the preferred cluster of stations, a cluster identification of the preferred cluster of stations, a discovery window schedule of the preferred cluster of stations, and an operating channel number of the preferred cluster of stations.

27. The method of claim 23, the request received from the access point being based on information from the first station, the current cluster of stations identified by the access point being based on a current cluster of stations to which the first station belongs.

28. The method of claim 23, the search for the preferred cluster of stations being based on clusters of stations information stored by the access point.

29. The method of claim 23, the search for the preferred cluster of stations further comprising:
sending at least one inquiry to at least one second station on the network; and
receiving at least one inquiry-response from the at least one second station.

30. The method of claim 29, the inquiry including at least one of: a location of the access point, a cluster identification of the current cluster of stations, and cluster metrics associated with the current cluster of stations, and the at least one inquiry-response received from the at least one second station comprising at least one of: a location of the preferred cluster of stations, a cluster identification of the preferred cluster of stations, a discovery window schedule of the preferred cluster of stations, and an operating channel number of the preferred cluster of stations.
